(19) United States
(12) Patent Application Publication
(10) Pub. No.: US 2024/0010773 A1
(43) Pub. Date: Jan. 11, 2024

(54) Process to Produce Long Chain Branching in EPDM and Product

(71) Applicant: Dow Global Technologies LLC, Midland, MI (US)

(72) Inventors: Lixin Sun, Lake Jackson, TX (US); Guang Ming Li, Lake Jackson, TX (US); Santosh S. Bawiskar, Lake Jackson, TX (US); Xiaosong Wu, Lake Jackson, TX (US); Colin Li Pi Shan, Lake Jackson, TX (US)

(21) Appl. No.: 18/253,758

(22) PCT Filed: Nov. 23, 2021
(86) PCT No.: PCT/US2021/060471

§ 371 Date: May 19, 2023

Related U.S. Application Data
(60) Provisional application No. 63/117,808, filed on Nov. 24, 2020.

(51) Int. Cl. C08F 210/18; C08F 210/06; C08F 8/48

(52) U.S. Cl. CPC C08F 210/18; C08F 210/06; C08F 8/48

(57) ABSTRACT

The present disclosure provides a process and resultant composition. In an embodiment, the process includes providing an ethylene/propylene/non-conjugated polyene terpolymer (EPDM) having at least 3.5 wt % non-conjugated polyene. The process includes reacting the EPDM with a metal-Lewis acid, and forming a rheology-modified EPDM. The rheology-modified EPDM has (i) a z average molecular weight (Mz) from greater than 500,000 g/mole to 10,000,000 g/mole, (ii) a Mz/Mw from 3 to 10, (iii) a g value from 0.4 to 1.0, (iv) a z value from 1.0 to 3.5, (v) a Mooney viscosity from 50 to 150, and (vi) a tan delta value from 0.1 to less than 1.0.

### BACKGROUND

Known are ethylene-propylene-diene monomer terpolymers (EPDM) having a molecular architecture that includes long chain branching (LCB). LCB introduces side chains into the backbone of the EPDM that alter the rheological and physical properties of the EPDM significantly, e.g., the elasticity and shear thinning character of the EPDM is increased with LCB. The benefits of high-LCB EPDM compared to non-branched EPDM include reduced cold flow, higher green strength, higher collapse resistance during extrusion of hollow parts, better foamability, faster extrusion rates, faster mixing, lower energy consumption in internal mixers, higher filler loading and reduced melt fracture.

The choice of catalyst used in the polymerization and the polymerization process conditions provide methods of adapting the level of LCB in the EPDM architecture. Ziegler Natta (Z-N) catalysts (e.g., titanium-based catalyst or vanadium-based catalyst), can introduce LCB into an EPDM during the polymerization process. However, the extent of LCB is difficult to control, e.g., the Z-N polymerization process is prone to forming undesirable crosslinked EPDM that leads to gel formation. The Z-N polymerization process also produces EPDM with broad composition distribution and broad molecular weight distribution.

Metallocene catalysts (e.g., zirconium based catalyst), produce EPDM in a solution polymerization process. Metallocene catalysts generally produce EPDM having a more uniform composition distribution, narrower MWD and a more linear molecular architecture compared to Z-N catalyzed EPDM. However, metallocene catalysts typically produce low levels of LCB compared to Z-N catalyzed EPDM.

Consequently, the art recognizes the need for high-LCB EPDM. The art further recognizes the need for methods of increasing LCB in metallocene catalyzed EPDM.

### SUMMARY

The present disclosure provides a process. In an embodiment, the process includes providing an ethylene/propylene/non-conjugated polyene terpolymer (EPDM) having at least 3.5 wt % non-conjugated polyene. The process includes reacting the EPDM with a metal-Lewis acid; and forming a rheology-modified EPDM. The rheology-modified EPDM has (i) a z average molecular weight (Mz) from greater than 500,000 g/mole to 10,000,000 g/mole, (ii) a Mz/Mw from 3 to 10, (iii) a g value from 0.4 to 1.0, (iv) a z value from 1.0 to 3.5, (v) a Mooney viscosity from 50 to 150, and (vi) a tan delta value from 0.1 to less than 1.0.

The present disclosure provides a composition. In an embodiment, the composition includes an ethylene/propylene/non-conjugated polyene terpolymer (EPDM) having at least 3.5 wt % non-conjugated polyene. The ethylene/propylene/non-conjugated polyene terpolymer (EPDM) has (i) a z average molecular weight (Mz) from greater than 500,000 g/mole to 10,000,000 g/mole, (ii) a Mz/Mw from 3 to 10, (iii) a g value from 0.4 to 1.0, (iv) a z value from 1.0 to 3.5, (v) a Mooney viscosity from 50 to 150, and (vi) a tan delta value from 0.1 to less than 1.0.

### BRIEF DESCRIPTION OF THE DRAWINGS

FIG. 1 is a schematic representation of carbocationic coupling in accordance with an embodiment of the present disclosure.

FIG. 2 is a graph showing tan delta values for EPDM1 and inventive example 23 in Table 2.

FIG. 3 is a graph showing GPC curves of EPDM samples before reaction with metal-Lewis acid and after reaction with metal-Lewis acid.

### DEFINITIONS

All references to the Periodic Table of the Elements herein shall refer to the Periodic Table of the Elements, published and copyrighted by CRC Press, Inc., 2003. Also, any references to a Group or Groups shall be to the Group or Groups reflected in this Periodic Table of the Elements using the IUPAC system for numbering groups.

For purposes of United States patent practice, the contents of any referenced patent, patent application or publication are incorporated by reference in their entirety (or its equivalent U.S. version is so incorporated by reference), especially with respect to the disclosure of definitions (to the extent not inconsistent with any definitions specifically provided in this disclosure) and general knowledge in the art.

The numerical ranges disclosed herein include all values from, and including, the lower value and the upper value. For ranges containing explicit values (e.g., 1, or 2, or 3 to 5, or 6, or 7) any subrange between any two explicit values is included (e.g., 1 to 2; 2 to 6; 5 to 7; 3 to 7; 5 to 6; etc.).

Unless stated to the contrary, implicit from the context, or customary in the art, all parts and percentages are based on weight and all test methods are current as of the filing date of this disclosure.

The term “composition,” as used herein, refers to a mixture of materials which comprise the composition, as well as reaction products and decomposition products formed from the materials of the composition.

The terms “comprising,” “including,” “having,” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, (whether polymerized or otherwise), unless stated to the contrary. In contrast, the term, “consisting essentially of” excludes from the scope of any succeeding recitation any other component, step, or procedure, excepting those that are not essential to operability. The term “consisting of” excludes any component, step, or procedure not specifically delineated or listed. The term “or,” unless stated otherwise, refers to the listed members individually as well as in any combination. Use of the singular includes use of the plural and vice versa.

An “ethylene-based polymer,” is a polymer that contains more than 50 weight percent polymerized ethylene monomer (based on the total amount of polymerizable monomers) and, optionally, may contain at least one comonomer. Ethylene-based polymer includes ethylene homopolymer, and ethylene copolymer (meaning units derived from ethylene and one or more comonomers). The terms “ethylene-based polymer” and “polyethylene” may be used interchangeably. Nonlimiting examples of ethylene-based polymer (polyethylene) include low density polyethylene (LDPE) and linear polyethylene. Nonlimiting examples of linear polyethylene include linear low density polyethylene (LLDPE), ultra-low density polyethylene (ULDPE), very low density polyethylene (VLDPE), multi-component ethylene-based copolymer (EPE), ethylene/α-olefin multi-block copolymers (also known as olefin block copolymer (OBC)), single-site catalyzed linear low density polyethylene (m-LLDPE), substantially linear, or linear, plastomers/elastomers, and high density polyethylene (HDPE). Generally, polyethylene may be produced in gas-phase, fluidized bed reactors, liquid phase slurry process reactors, or liquid phase solution process reactors, using a heterogeneous catalyst system, such as Ziegler-Natta catalyst, a homogeneous catalyst system, comprising Group 4 transition metals and ligand structures such as metallocene, non-metallocene metal-centered, heteroaryl, heterovalent aryloxyether, phosphinimine, and others. Combinations of heterogeneous and/or homogeneous catalysts also may be used in either single reactor or dual reactor configurations. In an embodiment, the ethylene-based polymer does not contain an aromatic comonomer polymerized therein.

A “hydrocarbon” is a compound containing only hydrogen and carbon atoms. A hydrocarbon can be branched or unbranched, saturated or unsaturated, cyclic, polycyclic or acyclic species, and combinations thereof.

The terms “interpolynner,” and “copolymer,” refer to a polymer prepared by the polymerization of at least two different types of monomers. These generic terms include both classical copolymers, i.e., polymers prepared from two different types of monomers, and polymers prepared from more than two different types of monomers, e.g., terpolymers, tetrapolymers, etc.

A “Lewis acid” is a substance that can accept a pair of electrons; a Lewis acid is an electron-pair acceptor. A H⁺ cation is a nonlimiting example of a Lewis acid. A “Lewis base” is a substance that donates a pair of electrons; a Lewis base is an electron-pair donor. A OH⁻ anion is a nonlimiting example of a Lewis base.

The term “long-chain branching,” or (“LCB”), as used herein, refers to the presence of side chains on an ethylene/propylene/diene-monomer terpolymer with the side chain molecular weight being greater than the entanglement molecular weight of the polymer.

The term “polymer,” refers to a material prepared by reacting (i.e., polymerizing) a set of monomers, wherein the set is a homogenous (i.e., only one type) set of monomers or a heterogeneous (i.e., more than one type) set of monomers. The term polymer as used herein includes the term “homopolymer”, which refers to polymers prepared from a homogenous set of monomers, and the term “interpolynner” as defined below.

The term “terpolynner,” refers to a polymer prepared by the polymerization of three different types of monomers.

### Test Methods

Density is measured in accordance with ASTM D792, Method B. The result is recorded in grams per cubic centimeter (g/cc or g/cm³).

Mooney viscosity test: EPDM Rubber Mooney Viscosity is measured in a Mooney shearing disk viscometer in accordance with ASTM 1646-04. The instrument is an Alpha Technologies Mooney Viscometer 2000. The torque to turn the rotor at 2 rpm is measured by a torque transducer. The sample is preheated for 1 minute (min) after the platens is closed. The motor is then started and the torque is recorded for a period of 4 min. Results are reported as “ML (1+4) at 125° C.” in Mooney Units (MU). The term “ML” indicates that a large rotor, “Mooney Large,” is used in the viscosity test, where the large rotor is the standard size rotor. Mooney viscosity (MV) measures the resistance of polymer to flow at a relatively low shear rate and indicates the flowability of the polymer.

Rubber rheology property analysis (RPA): Rubber rheology property analysis is performed in accordance with ASTM D6204 with a rotorless oscillating shear rheometer (i.e., rubber process analyzer (RPA)). RPA frequency sweep test is performed using an Alpha Technologies RPA 2000. The testing sample is cut out with a Cutter 2000R. Sample size is between 5 and 7 grams. The test specimen is considered to be of proper size (116 to 160% of the test cavity volume) when a small bead of rubber compound is extruded uniformly around the periphery of the dies as they are closed. The sample is placed between two pieces of Mylar film. A frequency sweep is performed at 125° C. using a 5% strain for the neat terpolymers. The frequency range is from 0.1 radians per second (rad/s) to 100 rad/s. The stress response was analyzed in terms of amplitude and phase, from which, the storage shear modulus (G′), loss shear modulus (G″), complex viscosity (V), tan delta (i.e., phase angle δ), and complex shear modulus G* were calculated. Modulus values are reported in kilopascal (kPa), phase angle is reported in degrees, and viscosity is reported in pascal-seconds (Pa⋅s).

The term “rheology ratio” (or “RR”), is calculated as the ratio of the measured complex viscosity at 0.1 rad/sec and 125° C. (V0.1) to the measured complex viscosity at 100 rad/sec and 125° C. (V100); RR equals V0.1/V100 at 125° C.

The term Tan delta (tangent delta), tangent “phase angle δ,” as used herein, is the tangent phase angle lag exhibited between an applied stress and the resultant strain imparted by the stress. For a given dynamic mechanical study, the tangent delta (phase angle δ) is measured at a 0.1 rad/s shear rate and 125° C. When comparing the tangent delta (phase angle δ) of a group of polymers, decreased tan delta values generally indicate a polymer is more elastic and more Long Chain Branching.

High Temperature Gel Permeation Chromatography test (“HT GPC test”): The HT GPC test is conducted with a Polymer Char (Valencia, Spain) HT GPC system consisting of an infra-red concentration/composition detector (IR-5 detector), a PDI 2040 laser light scattering detector (Agilent), and a four capillary bridge viscometer (Malvern Panalytical) and allows determination of number average molecular weight (M_{N}), weight average molecular weight (M_{W}), and zeta average molecular weight (M_{Z}).

The columns are four mixed A LS 20 micrometer columns (Agilent). The detector compartments are operated at 160° C. and the column compartment is operated at 150° C. The carrier solvent is 1,2,4-trichlorobenzene (TCB) containing approximately 250 ppm of butylated hydroxytoluene (BHT) and is nitrogen sparged.

The HT GPC system is calibrated with 21 narrow molecular weight distribution polystyrene standards. The molecular weights of the standards ranges from 580 to 8,400,000 and are arranged in six 6 “cocktail” mixtures having at least a decade of separation between individual molecular weights. Molecular weight data (Mₚₛ), of the resultant polystyrene standards is converted to polyethylene molecular weight data (Mₚₑ), by the equation (1): Mₚₑ=A(Mₚₛ)^{B}; where the value of A is determined in an iterative manner and is approximately 0.42 and the value of B is 1.0. A third or fifth order polynomial was used to fit the respective polyethylene-equivalent calibration points obtained from the equation (1) to their observed elution volumes for each polystyrene standard.

M_{N}, M_{W}, and M_{Z} are calculated according to the following equations:

$$Mn = \frac{{\sum }^{i} {Wf}_{i}}{{\sum }^{i} ( {Wf}_{i} / {M}_{i} )} \qquad ( 2 )$$

$$Mw = \frac{{\sum }^{i} ( {Wf}_{i} * {M}_{i} )}{{\sum }^{i} {Wf}_{i}} \qquad ( 3 )$$

$$Mz = \frac{{\sum }^{i} ( {Wf}_{i} * {M}_{i}^{2} )}{{\sum }^{i} ( {Wf}_{i} * {M}_{i} )} \qquad ( 4 )$$

where, Wfᵢ is the weight fraction of the i-th elution component and Mᵢ is the molecular weight of the i-th elution component. The molecular weight distribution (MWD) is expressed as the ratio of M_{W} to M_{N}; M_{W}/M_{N}. The A value is determined by adjusting A value in equation (1) until the value of Mw from equation (3), and the corresponding retention volume polynomial, agree with the independently determined value of Mw obtained in accordance with a linear homopolyethylene reference having a known M_{W} of 120,000 and intrinsic viscosity (1.873 dL/g). The same linear homopolyethylene reference was used to determine the response factors of the IR-5 detector, the laser light scattering detector, and the viscometer. Determination of the response factors and detector off-sets are implemented in a manner consistent with that published in the American Chemical Society Publications: “A Strategy for Interpreting Multidetector Size-Exclusion Chromatography Data I,” in “Chromatography of Polymers (ACS Symposium Series, #521),” T. H. Mourey and S. T. Balke, Chap 12, p 180, (1993); and “A Strategy for Interpreting Multidetector Size-Exclusion Chromatography Data II,” in “Chromatography of Polymers (ACS Symposium Series, #521).” S. T. Balke, R. Thitiratsakul, R. Lew, P. Cheung, T. H. Mourey, Chap 13, p 199, (1993) the entire contents of both which is incorporated by reference herein.

The g value is used to characterize the amount of long chain branching introduced by the chemical treatment. The g value is the ratio of g′ value after and before the chemical treatment of the same terpolymer. The g′ value of the terpolymer, before and after the chemical treatment, was determined by the HT GCP test with triple detectors. The g′ value is the ratio of determined intrisic viscosity of the terpolymer using the calibrated viscometer and concentration detector, and the calculated intrinsic viscosity of a ethylene homopolymer with the same weight average molecular weight. The intrinsic viscosity of the ethylene homopolymer was calculated using the Mark-Houwink Equation, IV=k*Mw^{α}, with a k value of 4.06×10⁻⁴ and an α value of 0.725 (Th. G. Scholte, N. L. J. Meijerink, H. M. Schoffeleers, and A. M. G. Brands, J. Appl. Polym. Sci., 29, 3763-3782 (1984)). The calculated g value has an accuracy of ≤+/−2%.

The ratio of zeta average (or “z average”) molecular weight over weight average molecular weight (Mz/Mw) indicates the distribution at the high molecular weight end. High Mz/Mw indicates molecular weight distribution plot tailing to high molecular weight end, or increasing high molecular weight fraction. A z value, defined as the Mz/Mw of the resin after and before the chemical treatment. A z value larger than 1 indicates the chemical treatment increased high molecular weight relative content, which affects the resin melt elasticity.

Monomer content test: Ethylene content and propylene content of the terpolymers, as weight percentage, is determined by Fourier Transform Infrared (FTIR) analysis in accordance with ASTM D3900. ENB content of the terpolymers as a weight percentage is determined by Fourier Transform Infrared (FTIR) analysis in accordance with ASTM D6047.

Residual elemental analysis test: Residual elemental analysis is performed using both Inductively Coupled Plasma-Atomic Emission Spectroscopy (ICP-AES) and X-ray Fluorescence (XRF) techniques. For ICP-AES analysis, the samples are weighed into quartz tubes and 1 mL water and 3 mL nitric acid are added to the samples. The samples are placed in a hot block at 115° C. for 30 minutes. The samples are then placed in an UltraWave Microwave oven where they are digested at 250° C. After digestion in the microwave, the samples are diluted and analyzed by a Perkin Elmer ICP for aluminum (Al), magnesium (Mg), titanium (Ti), vanadium (V), and zirconium (Zr). For XRF analysis, the samples are formed in plaques in a hot press at 127° C. The samples are then rinsed with distilled water and then with acetone and chlorine content is measured by XRF. Results are reported in parts per million (ppm).

### DETAILED DESCRIPTION

### Process

The present disclosure provides a process. In an embodiment, the process includes
providing an ethylene/propylene/non-conjugated polyene terpolymer (EPDM) having at least 3.5 wt % non-conjugated polyene;
   reacting the EPDM with a metal-Lewis acid; and
   forming a rheology-modified EPDM having
   (i) a z average molecular weight (Mz) from greater than 500,000 g/mole to 10,000,000 g/mole,
   (ii) a Mz/Mw from 3 to 10,
   (iii) a g value from 0.4 to less than 1.0,
   (iv) a z value from 1.0 to 3.5,
   (v) a Mooney viscosity from 50 to 100, and
   (vi) a tan delta value from 0.1 to less than 1.0.

The process includes providing a terpolymer. The terpolymer is an ethylene/α-olefin/non-conjugated polyene terpolymer composed of, in polymerized form, ethylene, propylene, and at least 3.5 wt % of a non-conjugated polyene, based on total weight of the terpolymer. Nonlimiting examples of suitable nonconjugated polyenes include C₄-C₄₀ nonconjugated dienes.

In an embodiment, the nonconjugated polyene is an acyclic diene or a cyclic diene. Nonlimiting examples of acyclic dienes include straight chain acyclic dienes, such as 1,4-hexadiene and 1,5-heptadiene; and branched chain acyclic dienes, such as 5-methyl-1,4-hexadiene, 2-methyl-1,5-hexadiene, 6-methyl-1,5-heptadiene, 7-methyl-1,6-octadiene, 3,7-dimethyl-1,6-octadiene, 3,7-dimethyl-1,7-octadiene, 5,7-dimethyl-1,7-octadiene, and 1,9-deca-diene and mixed isomers of dihydromyrcene. Nonlimiting examples of cyclic dienes include monocyclic dienes such as 1,4-cyclohexadiene, 1,5-cyclooctadiene and 1,5-cyclododecadiene; multi-ring alicyclic fused and bridged ring dienes, such as tetrahydroindene and methyl tetrahydroindene; alkenyl, alkylidene, cycloalkenyl and cycloalkylidene norbornenes such as 5-methylene-2-norbornene (MNB), 5-ethylidene-2-norbornene (ENB), 5-vinyl-2-norbornene, 5-propenyl-2-norbornene, 5-isopropylidene-2-norbornene, 5-(4-cyclopentenyl)-2-norbornene, and 5-cyclohexylidene-2-norbornene.

In an embodiment, the nonconjugated polyene is ENB.

In an embodiment, the terpolymer includes only one type of non-conjugated polyene. The single type of non-conjugated polyene is void, or absent of a heteroatom.

In an embodiment, the terpolymer is an ethylene/propylene/norbornene terpolymer. In a further embodiment, the terpolymer is an ethylene/propylene/ENB terpolymer. The term “EPDM,” as used herein, is the ethylene/propylene/ENB terpolymer having only three monomers, and the ENB being the sole diene in the terpolymer.

In an embodiment, the terpolymer is a neat terpolymer. The term “neat,” as used herein, indicates a material that has no oil within, or upon, its structure. The term “neat,” as used herein, interchangeably indicates a material that is “oil-free.” In an embodiment, the EPDM is a neat EPDM, (i.e., “n-EPDM”).

In an embodiment, n-EPDM used herein is produced with a metallocene catalyst as described in U.S. Pat. No. 8,101,696 the entire contents of which is incorporated by reference herein.

In an embodiment, the EPDM is an n-EPDM and is composed of:
(i) from 40 to 70 wt %, or from 45 to 65 wt %, or from 50 to 60 wt % polymerized ethylene,
(ii) from 35 wt % to 65 wt %, or from 40 to 60 wt %, or from 45 to 55 wt % polymerized propylene,
(iii) from greater than 3.5 to 8.5 wt %, or from 3.6 to 7 wt %, or from 4 to 6 wt % polymerized ENB (wherein the aggregate amount of (i), (ii), (iii) is 100 wt % of the n-EPDM), and the n-EPDM has one, some, or all of the following properties:
(iv) a Mooney viscosity from 10 MU to 40 MU, or from 20 MU to 30 MU, and/or
(v) a density from 0.86 g/cc to 0.89 g/cc, or from 0.86 g/cc to 0.88 g/cc

The process includes reacting the terpolymer (e.g., n-EPDM) with a metal-Lewis acid. A “metal-Lewis acid” (or “mLA”), as used herein, is a Lewis acid containing one or more different types of metal atom. A “single metal-Lewis acid” (or “single mLA”) is a metal-Lewis acid containing a single type of metal. A “mixed metal-Lewis acid” (or “mixed mLA”), as used herein, is a Lewis acid containing two or more different types of metal atoms. The process includes reacting n-EPDM with from 100 ppm to 23,000 ppm, or from 200 ppm to 10,000 ppm, or from 300 ppm to 3,000 ppm mLA.

In an embodiment, the mLA is a single mLA and includes a metal atom selected from Al, V, Zr, Tin (Sn), or Boron (B).

In an embodiment, the mLA is a single mLA and includes from 300 ppm to 1000 ppm Al. In a further embodiment, the mLA is a single mLA that is AlCl₃ containing from 300 ppm to 1000 ppm Al metal.

In an embodiment, the mLA is a mixed mLA and includes at least one of Al, V, Zr, Sn, and/or B in combination with at least one of Mg and/or Ti.

In an embodiment, the process includes melt-mixing the EPDM and introducing the mLA into the melt-mixed EPDM to form the rheology-modified EPDM. Melt-mixing of the EPDM is accomplished by way of melt mixing (by way of Banbury mixer and/or Haake mixer), melt extrusion (single-screw extruder, twin-screw extruder, multi-screw extruder, continuous mixer or a kneader), and combinations thereof.

In an embodiment, the process includes dissolving the EPDM in solvent to form a mixture. The process includes introducing the metal-Lewis acid into the mixture; and forming the rheology-modified EPDM. The solvent is a C₆-C₂₀ hydrocarbon solvent, such as decane, for example. The EPDM is added to the C₆-C₂₀ hydrocarbon solvent to form a mixture. The metal-Lewis acid is added to the mixture. The mixture is heated to a temperature from 60° C. to 170° C., or from 95° C. to 160° C., to form the rheology-modified EPDM. The rheology-modified EPDM is retrieved from the reaction mixture.

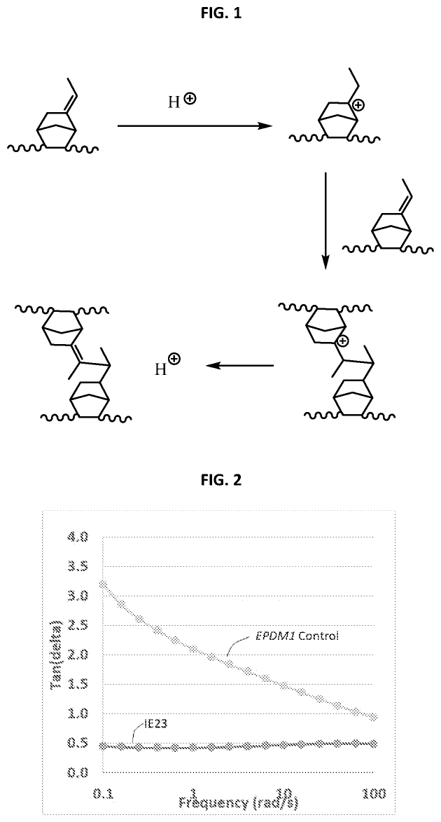

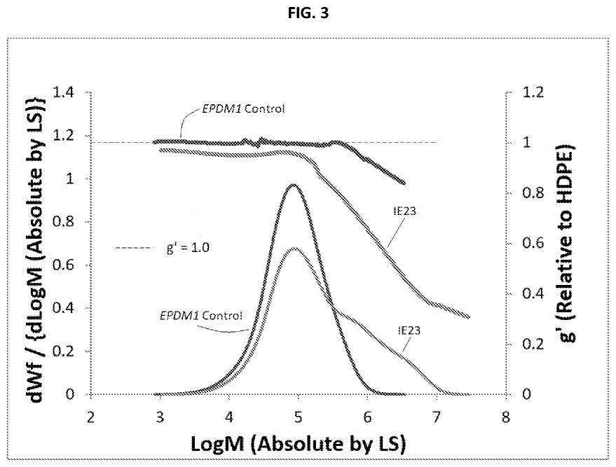

Bounded by no particular theory, it is believed that the reaction between the metal-Lewis acid and the EPDM results in carbocationic coupling between the polyene moieties in the EPDM. The reaction sequence of carbocationic coupling forms H-bonding between EPDM polymer strands across the polyene moieties (ENB) as shown in FIG. 1.

The process includes forming a rheology-modified EPDM. The rheology-modified EPDM contains (a) from 40 to 70 wt %, or from 45 to 65 wt %, or from 50 to 60 wt % polymerized ethylene, (b) from 35 wt % to 65 wt %, or from 40 to 60 wt %, or from 45 to 55 wt % polymerized propylene, (c) from greater than 3.5 to 8.5 wt %, or from 3.6 to 7 wt %, or from 4 to 6 wt % polymerized ENB (wherein the aggregate amount of (i), (ii), (iii) is 100 wt % of the rheology-modified EPDM), and the rheology-modified EPDM has one, some, or all of the following properties:
(i) a z average molecular weight (Mz) from greater than 500,000 g/mole to 10,000,000 g/mole, or from 700,000 g/mol to 8,000,000 g/mol, or from 1,000,000 g/mol to 6,000,000 g/mol; and/or
(ii) a Mz/Mw from 3 to 10, or from 3.4 to 8.0; and/or
(iii) a g value from 0.4 to 1.0, or from 0.5 to 0.9, or from 0.6 to 0.8; and/or
(iv) a z value from 1.0 to 3.5, or from 1.5 to 3.5, or from 2.0 to 3.5; and/or
(v) a Mooney viscosity from 50 to 100, or from 60 to 90; and/or
(vi) a tan delta from 0.1 to less than 1.0, or from 0.1 to 0.5, or from 0.1 to 0.3.

The process may comprise two or more embodiments disclosed herein.

### Composition

The present disclosure provides a composition. In an embodiment, the composition includes the rheology-modified EPDM, optional oil, and one or more optional additives. The rheology-modified EPDM contains (a) from 40 to 70 wt %, or from 45 to 65 wt %, or from 50 to 60 wt % polymerized ethylene, (b) from 35 wt % to 65 wt %, or from 40 to 60 wt %, or from 45 to 55 wt % polymerized propylene, (c) from greater than 3.5 to 8.5 wt %, or from 3.6 to 7 wt %, or from 4 to 6 wt % polymerized ENB (wherein the aggregate amount of (i), (ii), (iii) is 100 wt % of the rheology-modified EPDM), and the rheology-modified EPDM has one, some, or all of the following properties:
(i) a z average molecular weight (Mz) from greater than 500,000 g/mole to g/mole, or from 700,000 g/mol to 8,000,000 g/mol, or from 1,000,000 g/mol to 6,000,000 g/mol; and/or
(ii) a Mz/Mw from 3 to 10, or from 3.4 to 8.0; and/or
(iii) a g value from 0.4 to 1.0, or from 0.5 to 0.9, or from 0.6 to 0.8; and/or
(iv) a z value from 1.0 to 3.5, or from 1.5 to 3.5, or from 2.0 to 3.5; and/or
(v) a Mooney viscosity from 50 to 100, or from 60 to 90; and/or
(vi) a tan delta value from 0.1 to less than 1.0, or from 0.1 to 0.5, or from 0.1 to 0.3

### Additives

The present composition may optionally contain one or more additives.

In an embodiment, the composition includes the rheology-modified EPDM and an oil. Oils include, but are not limited to, petroleum oils, such as aromatic and naphthenic oils; polyalkylbenzene oils; organic acid monoesters, such as alkyl and alkoxyalkyl oleates and stearates; organic acid diesters, such as dialkyl, dialkoxyalkyl, and alkyl aryl phthalates, terephthalates, sebacates, adipates, and glutarates; glycol diesters, such as tri-, tetra-, and polyethylene glycol dialkanoates; trialkyl trimellitates; trialkyl, trialkoxyalkyl, alkyl diaryl, and triaryl phosphates; chlorinated paraffin oils; coumarone-indene resins; pine tars; vegetable oils, such as castor, tall, rapeseed, and soybean oils and esters and epoxidized derivatives thereof; and combinations thereof. In a further embodiment, the oil is selected from the group consisting of SUNPAR 2280, PARALUX 6001, HYDROBRITE 550, and CALSOL 5550.

In an embodiment, the composition includes the rheology-modified EPDM and oil. The oil is present in an amount from 5 wt %, or 15 wt %, or 20 wt % to 30 wt %, or 40 wt %, or 70 wt % based a total weight of the composition. In a further embodiment, the composition comprises the oil in an amount from 5 to 70 wt %, or from 15 to 40 wt %, or from 20 to 30 wt % based a total weight of the composition.

The oil may comprise a combination of two or more embodiments as described herein.

In an embodiment, the composition includes the rheology-modified EPDM and an additive (alone or in combination with the oil). Suitable additives include, but are not limited to, fillers, antioxidants and antiozonants, UV stabilizers, flame retardants, colorants or pigments, curing agents (e.g., sulphur, peroxides), accelerators, coagents, processing aids, blowing agents, plasticizers and combinations thereof.

Fillers include, but are not limited to, carbon black; silicates of aluminum, magnesium, calcium, sodium, potassium and mixtures thereof; carbonates of calcium, magnesium and mixtures thereof; oxides of silicon, calcium, zinc, iron, titanium, and aluminum; sulfates of calcium, barium, and lead; polyethylene glycol (PEG); sulfur; stearic acid; sulfonamide; alumina trihydrate; magnesium hydroxide; precipitated silica; fumed silica; natural fibers; synthetic fibers; and combinations thereof.

Antioxidants and antiozonants include, but are not limited to, hindered phenols, bisphenols, and thiobisphenols; and substituted hydroquinones.

In an embodiment, the composition includes the rheology-modified EPDM and calcium carbonate. In an embodiment, the calcium carbonate is present in an amount from 5 wt %, or 15 wt %, or 20 wt % to 30 wt %, or 40 wt %, or 70 wt % based a total weight of the composition. In a further embodiment, the calcium carbonate is present in an amount from 5 to 70 wt %, or from 15 to 40 wt %, or from 20 to 30 wt % based a total weight of the composition.

In an embodiment, the composition includes the rheology-modified EPDM and carbon black. In an embodiment, the carbon black is present in an amount from 5 wt %, or 15 wt %, or 20 wt % to 30 wt %, or 40 wt %, or 70 wt % based a total weight of the composition. In a further embodiment, the carbon black is present in an amount from 5 to 70 wt %, or from 15 to 40 wt %, or from 20 to 30 wt % based a total weight of the composition.

In an embodiment, the composition comprises an aggregate additive load, the load excluding calcium carbonate and carbon black. In an embodiment, the aggregate additive load is present in an amount from 0.5 wt %, or 1 wt %, or 2 wt % to 4 wt %, or 5 wt %, or 10 wt % based a total weight of the composition. In a further embodiment, the aggregate additive load is present in an amount from 0.5 to 10 wt %, or from 1 to 5 wt %, or from 2 to 4 wt % based a total weight of the composition.

The additive may comprise two or more embodiments disclosed herein.

The aggregate additive load may comprise two or more embodiments disclosed herein.

The composition can be used to form an article. Nonlimiting examples of articles that can be formed with the composition include automotive parts (automotive door sealants, automotive belts, automotive hoses), belts, building materials, cable, computer parts, extruder profiles, foams, footwear, gaskets, hose, membranes, molded goods, roofing sheets, sponges, tires, weather stripping, and wire.

By way of example, and not limitation, some embodiments of the present disclosure will now be described in the following examples.

### EXAMPLES

The raw materials used to formulate the Comparative Samples (“CS”) and the Inventive Examples (“IE”) are provided in Table 1 below.

TABLE 1

| Trade Name | Description | Supplier |
|---|---|---|
| NORDEL 4520 | density: 0.86 g/cc | The Dow Chemical |
| (“EPDM1”) | 50 wt % C₂H₄; 4.9 wt % | Company |
| | ENB; 20 MU | |

In a drybox under nitrogen atmosphere, EPDM1 was dissolved in decane to form a 10 wt % solution in a glass vial equipped with a magnet stir bar. Samples were made by introducing various m-Lewis acids (mLA) in differing amounts to individual portions of the dissolved EPDM1 solution. After addition of the mLA, each mixture was heated to a temperature from 95° C. to 160° C. After 30 minutes, each mixture was precipitated in methanol, filtered and dried at 70° C. in vacuum oven for 5 hours. Properties of the rheology-modified EPDM1's are shown in Table 2 below.

TABLE 2
Properties of rheology-modified EPDM1

| | | | | Metal in polymer | | | Absolute GPC | | | | | | |
|---|---|---|---|---|---|---|---|---|---|---|---|---|---|
| | | | Temp | (ppm) | | | | | | Mw/ | Mz/ | g | z |
| | EPDM1 | Lewis Acid | (° C.) | Al | Ti | Mg | Mn | Mw | Mz(abs) | Mn | Mw | value | value |
| Con- | 0.3 | 0 | | 0 | 0 | 0 | 53,041 | 135,313 | 320,296 | 2.55 | 2.37 | 1.00 | 1.00 |
| trol | | | | | | | | | | | | | |
| CS1 | 0.3 | AlCl₃ | 130 | 67 | 0 | 0 | 52,113 | 136,174 | 328,557 | 2.61 | 2.41 | 1.00 | 1.02 |
| IE2 | 0.3 | AlCl₃ | 130 | 330 | 0 | 0 | 53,942 | 162,359 | 566,533 | 3.01 | 3.49 | 0.94 | 1.47 |
| IE3 | 0.3 | AlCl₃ | 130 | 675 | 0 | 0 | 56,932 | 224,731 | 1,576,535 | 3.95 | 7.02 | 0.93 | 2.96 |
| CS4 | 0.3 | AlCl₃ | 130 | 2680 | 0 | 0 | — | — | — | — | — | — | — |
| CS5 | 0.3 | AlCl₃ | 130 | 6750 | 0 | 0 | — | — | — | — | — | — | — |
| CS6 | 0.3 | TiCl₄ | 130 | 0 | 1197 | 0 | 55,537 | 144,871 | 314,386 | 2.61 | 2.17 | 1.02 | 0.92 |
| CS7 | 0.3 | TiCl₄ | 130 | 0 | 2395 | 0 | 53,222 | 142,408 | 303,262 | 2.68 | 2.13 | 1.02 | 0.90 |
| CS8 | 0.3 | TiCl₄ | 130 | 0 | 4790 | 0 | 54,861 | 142,103 | 296,066 | 2.59 | 2.08 | 1.01 | 0.88 |
| IE9 | 1.0 | EtAlCl₂ | 130 | 2160 | 0 | 0 | 63,709 | 266,150 | 1,246,557 | 4.18 | 4.68 | 0.92 | 1.98 |
| CS10 | 1.0 | EtAlCl₂ | 130 | 540 | 0 | 0 | 58,932 | 165,000 | 402,030 | 2.80 | 2.44 | 1.02 | 1.03 |
| CS11 | 0.3 | MgCl₂ | 95 | 0 | 0 | 16200 | 54,784 | 141,367 | 304,513 | 2.58 | 2.15 | 0.77 | 0.91 |
| IE12 | 0.3 | MgCl₂—EtAlCl₂ (1:0.3) | 95 | 5400 | 0 | 16200 | 56,979 | 213,690 | 1,000,443 | 3.75 | 4.68 | 0.72 | 1.98 |
| CS13 | 12.0 | Ti(OiPr)₄—AlCl₃ (1:2.6) | 95 | 877 | 598 | 0 | 51,082 | 132,710 | 295,384 | 2.60 | 2.23 | 1.01 | 0.94 |
| IE14 | 0.3 | Ti(OiPr)₄—AlCl₃ (1:4) | 130 | 3240 | 1437 | 0 | 63,919 | 999,077 | 7,908,565 | 15.60 | 7.92 | 0.48 | 3.34 |
| IE15 | 0.3 | Ti(OiPr)₄—AlCl₃ (1:4) | 130 | 1260 | 559 | 0 | 53,523 | 186,781 | 583,680 | 3.50 | 3.12 | 0.91 | 1.32 |
| CS16 | 0.3 | Ti(OiPr)₄—EtAlCl₂ (1:4) | 130 | 3240 | 1437 | 0 | 54,862 | 137,084 | 301,888 | 2.50 | 2.20 | 0.83 | 0.93 |
| CS17 | 0.3 | Ti(OiPr)₄—EtAlCl₂ (1:4) | 130 | 6480 | 2874 | 0 | 50,362 | 134,612 | 309,628 | 2.67 | 2.30 | 0.96 | 0.97 |
| IE18 | 0.3 | Ti(OiPr)₄—EtAlCl₂—MgCl₂ (1:3:10) | 130 | 4050 | 2395 | 12180 | 53,438 | 503,608 | 2,991,442 | 9.42 | 5.94 | 0.73 | 2.51 |
| IE19 | 1.0 | Ti(OiPr)₄—EtAlCl₂—MgCl₂ (1:3:10) | 130 | 1215 | 718 | 3654 | 65,744 | 500,504 | 2,531,230 | 7.61 | 5.06 | 0.99 | 2.13 |
| IE20 | 1.0 | Ti(OiPr)₄—EtAlCl₂—MgCl₂ (1:3:10) | 130 | 607 | 359 | 1827 | 63,304 | 228,503 | 776,862 | 3.61 | 3.40 | 0.98 | 1.43 |
| IE21 | 1.0 | Ti(OiPr)₄—EtAlCl₂—MgCl₂ (1:3:10) | 160 | 1215 | 718 | 3654 | 52,826 | 258,923 | 1,133,392 | 4.90 | 4.38 | 0.91 | 1.85 |
| IE22 | 1.0 | Ti(OiPr)₄—EtAlCl₂—MgCl₂ (1:3:10) | 160 | 607 | 359 | 1827 | 59,386 | 186,224 | 520,280 | 3.14 | 2.79 | 0.99 | 1.18 |
| IE23 | 12.0 | Ti(OiPr)₄—EtAlCl₂—MgCl₂ (1:3:10) | 95 | 876 | 518 | 2636 | 66,645 | 699,485 | 5,294,821 | 10.60 | 7.57 | 0.72 | 3.19 |

CS = comparative sample,
IE = inventive example
Et = ethyl group
OiPr = isopropoxy group, (CH3)2CH—O—
g value is the ratio of g′ value (the intrinsic viscosity of polymer over the intrinsic viscosity of homo-polyethylene with the same weight average molecular weight) after chemical treatment and before chemical treatment
Z value is the ratio of Mz/Mw values after and before chemical treatment

TABLE 3
Rheology data from RPA test

| | | | | Tan Delta |
|---|---|---|---|---|
| | V0.1 (Pa · s) | V100 (Pa · s) | RR | @0.1 Rad/s |
| EPDM1 (control) | 77,806 | 3,880 | 20 | 1.94 |
| IE23 | 535,966 | 4,100 | 131 | 0.47 |

Table 2 shows the results of carbocationic coupling of a EPDM1 resin (NORDEL 4520 from Table 1) in solution using various single mLAs or mixed mLAs. The control in Table 2 is the base resin, EPDM1, which is subjected to the same dissolution and heating process as the comparative samples and the inventive examples; however, the control is not treated with a Lewis acid. In CS1, IE2, IE3, CS4, and CS5, Al was used as a single mLA. At low Al dosage (less than 300 ppm) in CS1 (67 ppm Al for CS1), no change was observed in molecular weight and/or branching in EPDM1. At high Al dosage, or greater than 1000 ppm Al, CS4 (2680 ppm Al for CS4) and CS5 (6750 ppm Al for CS5) resulted in insoluble polymers. Applicant discovered an unexpected range of 300ppm to 1000ppm Al for single mLA that is AlCl₃ for the production of acceptable rheology-modified EPDM. With the increase of the Al dosage to 330 ppm in IE2 and Al dosage to 675 ppm in IE3, single mLA AlCl₃ produced rheology-modified EPDM1 with high molecular weight tails (IE2 Mz 566,533 g/mol, IE3 Mz 1,576,535 g/mol).

TiCl₄ with Ti as single metal does not function as a suitable single mLA. Comparative samples CS6-CS8 are samples treated by TiCl₄. Surprisingly, TiCl₄ did not cause coupling reaction even at high dosage. This is unexpected because TiCl₄ is a known initiator for cationic polymerization

Similarly, MgCl₂ with Mg as single metal does not function as suitable single mLA. MgCl₂ was non-effective for carbocationic coupling even at extremely high dosage (CS11).

EtAlCl₂ was an effective metal-Lewis acid as shown in inventive example IE9, but higher dosage was needed to achieve the same level of branching as compared to AlCl₃. Bounded by no particular theory, it is believed EtAlCl₂ is a milder Lewis acid than AlCl₃. While a stronger Lewis acid offers the advantage of higher effectiveness and lower dosage requirement, a milder Lewis acid offers the advantage of easier process control to avoid excessive crosslinking and undesired formation of gel.

The Lewis acidity of a metal Lewis acid can be modified by mixing with certain other metal(s). Inventive example IE12 was treated with a mixed mLA MgCl₂-EtAlCl₂ at 5400 ppm Al. IE12 exhibits a lower degree of coupling as indicated by lower Mw and Mz (IE12 Mw: 213,690 Mz: 1,000,443) compared to IE9 (IE9 Mw: 266,150 Mz: 1,246,557) where the Al content was 2160 ppm, suggesting that MgCl₂ further reduced the Lewis acidity of EtAlCl₂. Without being bounded by any theory it is believed that Mg donated electrons to the Al through an Mg→Cl→Al bridge, rendering the Al sites less acidic.

Comparative sample CS13 was treated by mixed mLA Ti(OiPr)₄—AlCl₃ with 877 ppm Al. For CS13, Mw and Mz values remained unchanged indicating no coupling occurred. This makes an interesting comparison to IE3 where significant coupling was observed with AlCl₃ at only 675 ppm Al. Increasing Al to Ti ratio resulted in more effective coupling (IE14-15). Without being bounded by any theory, it is believed that some isopropoxy groups migrated to Al through ligand exchange rendering lower Lewis acidity of the Al sites. Applicant discovered that using a mixed metal system unexpectedly provides a way to achieve balanced Lewis acidity. A larger sample (IE23) was prepared using a three metal system for rheology test.

It is specifically intended that the present disclosure not be limited to the embodiments and illustrations contained herein, but include modified forms of those embodiments including portions of the embodiments and combinations of elements of different embodiments as come with the scope of the following claims.

1. A process comprising:
providing an ethylene/propylene/non-conjugated polyene terpolymer (EPDM) having at least 3.5 wt % non-conjugated polyene;
reacting the EPDM with a metal-Lewis acid that is a mixed metal-Lewis acid; and
forming a rheology-modified EPDM having
(i) a z average molecular weight (Mz) from greater than 500,000 g/mole to 10,000,000 g/mole,
(ii) a Mz/Mw from 3 to 10,
(iii) a g value from 0.4 to 1.0,
(iv) a z value from 1.0 to 3.5,
(v) a Mooney viscosity from 50 to 150, and
(vi) a tan delta value from 0.1 to less than 1.0.

2. The process of claim 1 wherein the reacting comprises melt-mixing the EPDM;
introducing the metal-Lewis acid into the melt-mixed EPDM; and
forming the rheology-modified EPDM.

3. The process of claim 1 comprising
dissolving the EPDM in solvent to form a mixture;
introducing the metal-Lewis acid into the mixture; and
forming the rheology-modified EPDM.

4. The process of claim 3 comprising
adding the EPDM to a C₆-C₂₀ hydrocarbon solvent;
heating the mixture to a temperature from 90° C. to 170° C.; and
dissolving the EPDM in the C₆-C₂₀ hydrocarbon solvent.

5. (canceled)

6. The process of claim 1 wherein the mixed metal-Lewis acid is composed of at least one of Al, V, Zr, Sn or B in combination with at least one of Mg or Ti.

7. A composition comprising:
an ethylene/propylene/non-conjugated polyene terpolymer (EPDM) having at least 3.5 wt % non-conjugated polyene;
(i) a z average molecular weight (Mz) from greater than 500,000 g/mole to 10,000,000 g/mole,
(ii) a Mz/Mw from 3 to 10,
(iii) a g value from 0.4 to 1.0,
(iv) a z value from 1.0 to 3.5,
(v) a Mooney viscosity from 50 to 150, and
(vi) a tan delta value from 0.1 to less than 1.0.

8. The composition of claim 7 wherein the EPDM is neat.

9. The composition of claim 7 wherein the EPDM comprises
(i) from 35 wt % to 75 wt % ethylene;
(ii) from 25 wt % to 65 wt % propylene; and
(iii) from greater than 3.5 wt % to 8.5 wt % polyene.

10. The composition of claim 7 wherein the polyene is 5-ethylidene-2-norbornene (ENB).

11. The process of claim 6 wherein the mixed metal-Lewis acid includes a metal combination selected from the group consisting of (i) Mg and Al, (ii) Ti and Al, and (iii) Ti, Al, and Mg.

12. The composition of claim 7, wherein the composition includes at least one of Al, V, Zr, Sn or B in combination with at least one of Mg or Ti.

13. The composition of claim 12 wherein the composition includes a metal combination selected from the group consisting of (i) Mg and Al, (ii) Ti and Al, and (iii) Ti, Al, and Mg.
